(19) United States
(12) Patent Application Publication
(10) Pub. No.: US 2014/0346787 A1
(43) Pub. Date: Nov. 27, 2014

(54) Safe and Secure Door Plate

(71) Applicants: Paul T. Martin, Jr., Oneida, NY (US); Mary Jane Martin, Oneida, NY (US)

(72) Inventors: Paul T. Martin, Jr., Oneida, NY (US); Mary Jane Martin, Oneida, NY (US)

(21) Appl. No.: 14/281,546

(22) Filed: May 19, 2014

Related U.S. Application Data
(60) Provisional application No. 61/826,739, filed on May 23, 2013.

(51) Int. Cl. E05C 19/18

(52) U.S. Cl. CPC E05C 19/182
USPC 292/289

(57) ABSTRACT

A door plate provides better safety and security. The plate cannot be kicked in or provide access to a door to be picked. The door plate, in conjunction with a doorjamb, makes one strong unit. The door plate wraps the vulnerable area of the doorjamb with its steel property thus becomes more impervious to splitting the edge of the doorjamb or any part of the protected area of the wrapping.

### TECHNICAL FIELD

The door plate pertains to safely securing doors in particular in strengthening a door's jamb.

### BACKGROUND OF THE INVENTION

A home is broken into every 14.5 seconds. Either the door is kicked in or the door latch is pried open with the use of a credit card. Many of the composite doors are strengthened with metal but this is not enough to prevent one from kicking in the door. What is needed is an unparalleled door protection again kicking in doors or compromising the door bolts by strengthening the door's jamb.

Currently, a doorjamb does not prevent the door from being kicked in with brunt force. A brunt force will split the jamb out on the inside edge or have the door jamb split enough for the door to open.

### SUMMARY OF THE INVENTION

The present invention prevents exterior wooden doorjambs from being kicked in through the use of a door plate. The door plate enhances the effectiveness of dead bolts, prevents punching door bolts in, and deters thieves from credit carding the dead bolts.

The present invention strengthens the doorjamb with a steel door plate making the door jamb, in conjunction with the plate, “practically one unit” by wrapping the vulnerable area of the jamb with the steel. The doorjamb becomes more impervious to splitting at the edge or any part of the “protected” area.

The present invention includes a steel plate that wraps the doorjamb under the exterior brick molding and wraps the inside edge under the interior trim casing and extends above and below the door unit.

The invention profiles the doorjamb and wraps the doorjamb from exterior to interior while strengthening the jamb and any lock assembly. It eliminates the weakness in existing current doorjambs that are made of wood, which can easily split wholly or partially.

Some of the benefits include:

1. Flanges inside and out to make the doorjamb secure;
2. Profiles to match the doorjamb;
3. Provides reinforcement to stop deflection;
4. Opens latch areas to allow change service or additions without removal of the secure and safe plate; and,
5. Reverses to be installed in a left side or a right side hinging door.

This makes the doorjamb stronger in the applied area. The latch area strongly resists splitting from exterior efforts. The plate enhances strength while making it aesthetically pleasing. A gusset or hem stops the secure plate from bending or flexing at a critical point. The invention allows for changing regular latch plates or adding another lock assembly at any time after the plate is installed.

The plate includes “wrapping flanges” that hold the jamb secure and distribute any force applied to the door over a large area on the face edge of the jamb to disperse and weaken the force of a blow. A center reinforcement web resists flexing but in turn absorbs and negates some of the force. The wrapping flanges also stop the inside of the doorjamb from splitting away. The reinforcement web area also protects the latch bolts from easy access for breaching. The reinforcement web makes it extremely difficult to pry the door bolt back from its latch plate to open the door without turning a doorknob. The result is a far more secure door assembly.

The instant invention would be made from steel and could be pressed out from flat stock or bent in presses. The door plate areas could be punched out in another press. The screw holes would then be drilled or the entire unit could be cast in a mold and the prefinished unit plated with bright brass, antique brass, or nickel for the end finish.

The instant invention is envisioned to have added a plate for a deadbolt and could be made as part of the plate. This plate would work for left or right hinging doors with no alteration and if a deadbolt plate were part of this then you would have to have a reversed unit to fit opposite swing doors.

While this unit is configured for a four inch wall or door jamb it would need to stretched two inches in width to accommodate a six inch door jamb.

It is envisioned that the reinforcement web is a bent hem or a lip welded to a second lip representing a gusset.

Install the plate on the doorjamb leaving spaces open where an existing latch plates are located. Briefly hold the safety plate in place over the doorjamb and mark the top, bottom and center of the unit on the doorjamb. Cut the weather stripping that would be covered by the new plate. Remove the weather stripping that was cut and set aside. Gently pry the exterior and interior trim away from the doorjamb. Now slide the new plate into position and attach with four screws. Glue the weather strip back in place or use the self-sticking strip that came with the new plate. Adjust the moldings as needed.

### BRIEF DESCRIPTION OF THE DRAWINGS

FIG. 1 shows an isometric left side view of a doorjamb in conjunction with the safety plate.

FIG. 2 shows an isometric right side view of the doorjamb in conjunction with the safety plate.

FIG. 3 shows a blown-up view of section 3-3 shown in FIG. 2.

FIG. 4 shows an isometric view of the safety plate.

FIG. 5 shows a front view of the safety plate shown in FIG. 4.

FIG. 6 shows a top view of the safety plate shown in FIG. 4.

FIG. 7 shows an isometric view of a second embodiment of a safety plate.

FIG. 8 shows a front view of the safety plate shown in FIG. 7.

FIG. 9 shows a top view of the safety plate shown in FIG. 7.

### DETAILED DESCRIPTION

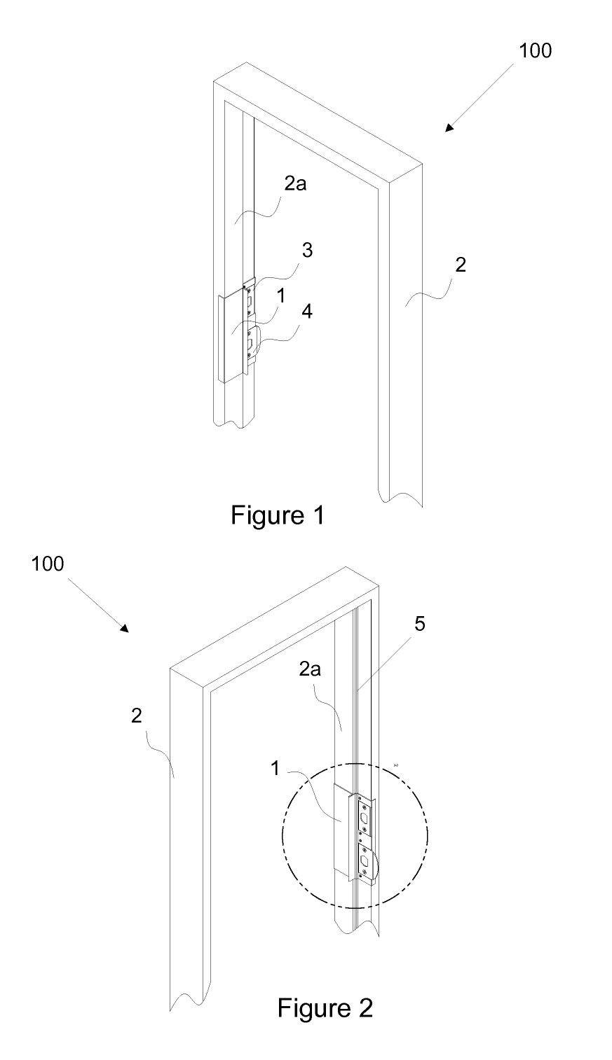

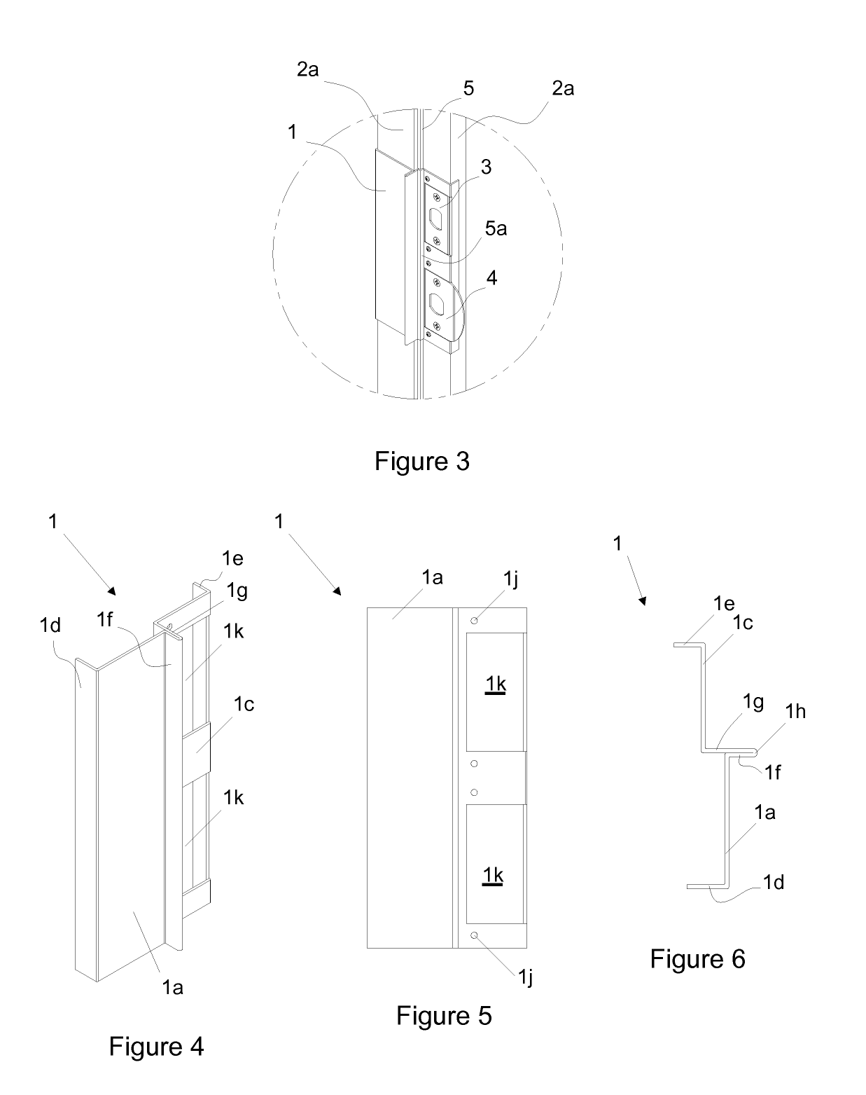

FIG. 1 shows a jamb and safety plate assembly 100. The assembly comprises an ordinary doorjamb 2 including a step 2a. FIG. 1 shows the assembly 100 without any exterior brick molding or the interior trim casing. FIGS. 1 and 2 show a safety plate 1 fixed to the doorjamb 2 and two strike plates 3, 4 of a lock unit and deadbolt unit not shown. Adjacent to the step 2a, a weather strip 5 runs along the boarder of the doorjamb and a portion of a weather strip 5a is affixed to over the safety plate 1 as shown in FIGS. 2 and 3.

FIGS. 4-6 show the details of the safety plate 1. The safety plate 1 is comprised of a first web 1a and a second web 1c with a reinforcement hem 1h shown in FIG. 6. The first web 1a and the second web 1c are offset and parallel to each other. The reinforcement hem 1h is comprised of a first lip 1f extending perpendicular to the first flange 1a and bending to a second lip 1g that perpendicularly intersects the second web 1c. As shown in FIG. 5, the second web 1c includes at least one opening 1k. In the example of FIG. 5, the second web 1c includes two openings 1k where two strike plates 3, 4 fit and can be fixed to the doorjamb 2. The second web 1c includes at least one fastening hole 1j. Although, it is envisioned that at least one fastening hole 1j be on the second web 1c, more than one fastening hole can be located anywhere in the safety plate 1 to fasten the safety plate 1 to the doorjamb 2.

As shown in FIGS. 4 and 6, the first web 1a and the second web 1c respectively includes at least one wrapping flange comprising a first wrapping flange 1d and a second wrapping flange 1e. The first wrapping flange 1d extends opposite to the first lip 1f and the second wrapping flange 1e extends opposite to the second lip 1g. Both wrapping flanges 1d, le extend parallel and in the same direction to each other.

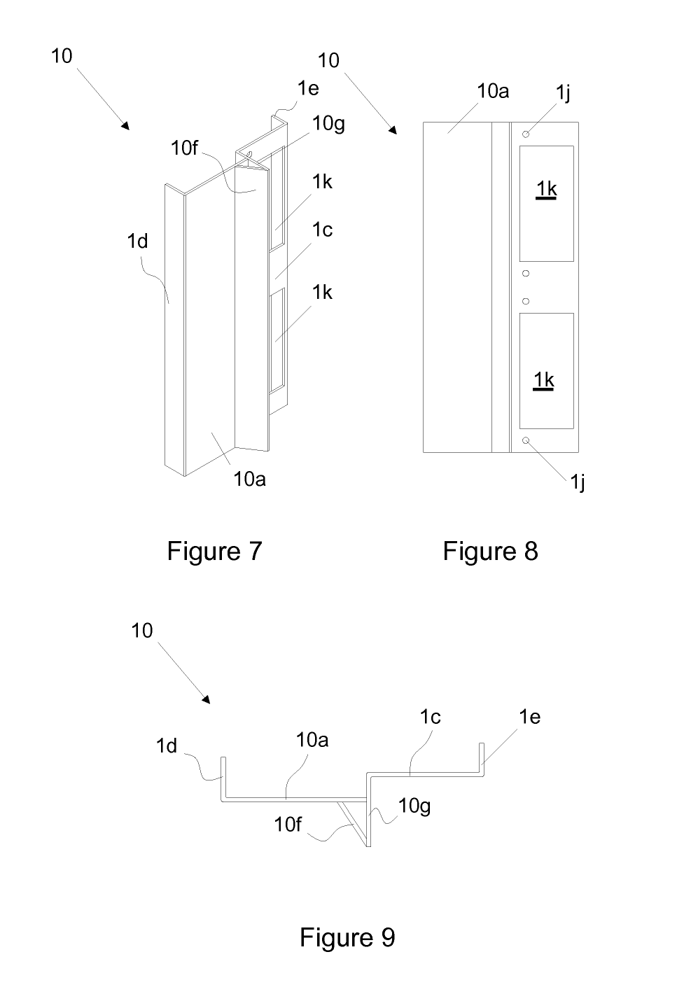

FIGS. 7-9 show a second embodiment of the safety plate 10. Some features are the same as the first embodiment of the safety plate 1 shown in FIGS. 4-6. The safety plate 10 includes a first web 10a and a second web 1c. The first web 10a and the second web 1c are offset and parallel to each other. A reinforcement web comprised of a first lip 10f extending at an angle to the first flange 10a and connecting to a second lip 10g that perpendicularly intersects the second web 1c. As shown in FIG. 8, the second web 1c includes at least one opening 1k. In the example of FIG. 8, the second web 1c includes two openings 1k where two strike plates 3, 4 can fit and be fixed to the doorjamb 2. The second web 1c includes at least one fastening hole 1j. The first lip 10f is welded to the first web and the second lip 10g.

As shown in FIGS. 7 and 9, the first web 10a and the second web 1c respectively includes at least one wrapping flange comprising a first wrapping flange 1d and a second wrapping flange 1e. The first wrapping flange 1d and the second wrapping flange 1e extend opposite to the second lip 10g. Both wrapping flanges 1d, 1e extend parallel and in the same direction to each other.

It should be understood that the strengthening hem 1h strengthens the safety plate overall and prevents thieves from credit carding any door lock. Similar in concept, the first lip 10f and the second lip 10g together strengthen the safety plate and deter thieves from credit carding any door lock. Although it is envisioned to make the safety plate 1, 10 from steel, the safety plate could as well be made from any known material. While the fastening hole 1j is circular, they can be countersunk or counterbore to accommodate a respective fastener.

1. A door plate comprising a first web, a second web, and a reinforcement web in between;
wherein the first web and the second web are connected to the reinforcement web;
wherein the first web and the second web are parallel to each other; and
wherein the second web comprises at least one opening for accepting a strike plate;

2. The door plate of claim 1, wherein the first web and the second web each include a wrapping flange parallel to each other; and,
wherein the wrapping flange respectively project in the same direction perpendicular to the first and second web.

3. The door plate of claim 1, wherein the second web includes at least one fastening hole.

4. The door plate of claim 2, wherein the second web includes at least one fastening hole.

5. The door plate of claim 1, wherein the reinforcement web comprises a first lip projecting perpendicular to the first web forming a hem with a second lip extending perpendicular to the second web.

6. The door plate of claim 2, wherein the reinforcement web comprises a first lip projecting perpendicular to the first web forming a hem with a second lip extending perpendicular to the second web.

7. The door plate of claim 6, wherein the first lip and the second lip extend opposite to the wrapping flanges.

8. The door plate of claim 1, wherein the reinforcement web comprises a first lip extending at an angle to the first web connecting to a second lip extending perpendicular to the second web.

9. The door plate of claim 2, wherein the reinforcement web comprises a first lip extending at an angle to the first web connecting to a second lip extending perpendicular to the second web.

10. The door plate of claim 9, wherein the second lip extends opposite to the wrapping flanges.
